(19) United States
(12) Patent Application Publication
(10) Pub. No.: US 2017/0165774 A1
(43) Pub. Date: Jun. 15, 2017

(54) Vertical Upward Welding in Which Wire Feed is Interrupted

(71) Applicants: Edward Arthur Haberoth, Gross Isle (CA); Baziuk Holdings Ltd., Winnipeg (CA)

(72) Inventor: Edward Arthur Haberoth, Gross Isle (CA)

(21) Appl. No.: 14/963,804

(22) Filed: Dec. 9, 2015

(51) Int. Cl. B23K 9/00; B23K 9/10; B23K 9/173; B23K 9/09; B23K 9/12

(52) U.S. Cl. CPC B23K 9/0026; B23K 9/09; B23K 9/125; B23K 9/173; B23K 9/1056

(57) ABSTRACT

A process for performing vertical upward using welding apparatus to form a weld bead on a workpiece that includes a welding gun and an electrode wire which is mechanically fed by the welding apparatus generally comprises (i) a step of welding the workpiece with the electrode wire feeding at a prescribed feed speed for a first predetermined duration where an arc is formed, and (ii) a step of halting the feeding of the electrode wire, as the welding gun is moved in the vertically upward direction, such that the arc is extinguished and so as to interrupt the step of welding for a second predetermined duration. As such, a weld pulse is formed, and by reiterating these steps a complete weld bead is formed from a plurality of the weld pulses.

### FIELD OF THE INVENTION

The present invention relates generally to welding using either one of a solid core electrode wire or a flux-cored electrode wire in which this electrode wire is mechanically fed to a workpiece such as through a welding gun, and more particularly to performing this type of welding in a vertically upward direction.

### BACKGROUND

Vertical welding is difficult using conventional methods/techniques which are known in the industry, and often requires significant skill. Typically, performing the vertical welding in a vertical downward direction is not advised. Although welding in a vertical upward direction may be preferred over the former downward version, the upward method is challenging because the rate of molten metal being deposited must match the rate of cooling very closely. If the rate of deposit of molten metal exceeds the rate of cooling, gravity will defeat the surface tension holding it in place. When this happens the weld puddle will sag entrapping impurities or falling from the workpiece entirely.

With these difficulties in mind, manufacturers or individuals who have the appropriate means are able to rotate their workpieces so as to perform the required welding in a flat position (where the workpiece is supported flat on a generally horizontal support surface) when it would otherwise have to be performed vertically. However, arrangements for lifting and rotating/revolving workpieces, like vehicles, are expensive and thus may not be readily accessible for many companies which perform welding as part of their livelihoods.

It is therefore desirable to provide a novel solution for vertically upward welding which may overcome potential shortcomings of the prior art.

### SUMMARY OF THE INVENTION

According to one aspect of the invention there is provided a process for performing vertical upward welding so as to form a weld bead on a workpiece using welding apparatus which includes a welding gun and an electrode wire which is mechanically fed by the welding apparatus, the process comprising the steps of:

a) providing preset parameters on the welding apparatus including (i) a voltage, and (ii) a wire feed speed;

b) welding the workpiece in a vertically upward direction with the welding apparatus set at said voltage and with the electrode wire feeding from the welding gun at said feed speed for a first predetermined duration where an arc is formed between the welding gun and the workpiece;

c) halting the feeding of the electrode wire as the welding gun is moved in said vertically upward direction, such that the arc is extinguished and so as to interrupt the step of welding in b) for a second predetermined duration;

whereby a weld pulse having a finite length is formed on the workpiece;

whereby the respective weld pulse is permitted to cool during step c);

wherein movement of the welding gun during step c) locates the welding gun at a next position at the workpiece in preparation for forming another one of the weld pulses when step b) is repeated;

wherein a plurality of the weld pulses form the weld bead.

The embodiment as described in more detail hereinafter provides alternating periods of (i) welding, when the arc is formed and power is transferred from the welding gun to the workpiece, and (ii) cooling/solidifying, when the arc is extinguished because the feeding of the electrode wire is stopped and power is not transferred from the welding gun to the workpiece. The alternation of active welding and intentional cooling results in formation of a plurality of weld pulses which collectively form a continuous weld bead across the workpiece. Each weld pulse has sufficient time to be properly formed and then cool so that the resulting weld bead is structurally sound. Thus, this embodiment may have a lower cost than prior art solutions so that it is more readily accessible. Additionally, this embodiment may be less skill-intensive so as to be less reliant on special skill/techniques and thereby usable by virtually any welder.

Preferably, the first predetermined duration is sized so that fusion with the workpiece occurs in step b) but molten metal resulting from said fusion is maintained in a suspended state at the workpiece in step b) without dripping from the workpiece.

Preferably, the second predetermined duration is sized based on a rate of cooling of the respective weld pulse.

Preferably, the second predetermined duration is sized so that the respective weld pulse which cools during step c) is in a plastic state when said another one of the weld pulses is applied when step b) is repeated therefor.

Preferably, the next position at which the welding gun is located in preparation for forming said another one of the weld pulses is at a top of the weld pulse applied previously thereto that is in the plastic state, such that said another one of the weld pulses is overlapped with the previous one of the weld pulses.

Preferably, there is zero background current throughout steps b) and c).

In one arrangement, the voltage is maintained at the welding gun during step c) while the wire is not feeding.

Preferably, steps b) and c) are managed by a controller which is cooperative with the welding apparatus such that a trigger action, which is enacted on the welding gun by a human user and operable for feeding the electrode wire from the welding gun, is regulated by the controller.

In one arrangement, the trigger action is in an active position throughout steps b) and c) where the electrode wire is arranged to be fed in this active position and the controller overrides the active position of the trigger action such that the wire is halted in step c).

Preferably, steps b) and c) are repeated for any respective number of iterations so long as the trigger action is in the active position.

In one arrangement, the first predetermined duration of time lies in a prescribed range between 0.01 seconds and 1.2 seconds.

In one arrangement, the second predetermined duration of time lies in a prescribed range between 0.2 seconds and 3 seconds.

### BRIEF DESCRIPTION OF THE DRAWINGS

One embodiment of the invention will now be described in conjunction with the accompanying drawings in which:

FIG. 1 is a schematic diagram of welding apparatus usable for employing a process for vertical upward welding according to the present invention.

FIG. 2 is a graph illustrating a variation of the wire feed speed over time in a process of performing vertical upward welding according to the present invention.

FIG. 3 is a schematic illustration of a weld bead in side elevation view where the weld bead is formed by the vertical upward welding process of the present invention as in FIG. 2 and using, for example, the welding apparatus of FIG. 1.

In the drawings like characters of reference indicate corresponding parts in the different figures.

### DETAILED DESCRIPTION

The accompanying figures illustrate a process for vertical upward welding according to the present invention. The process of the present invention is suited for a type of welding where a consumable wire electrode is delivered by welding apparatus to a workpiece. That is, the type of welding to which the present invention is related is that which comprises mechanically fed electrode wire. For example, one such type of welding comprises gas metal arc welding, and MIG welding is one form of gas metal arc welding with which the process of the present invention is suited. The process of the present invention may be employed on a number of metals including carbon steel, stainless steel, and aluminum, or more specifically on alloys of these metals which can be welded or are suitable for welding.

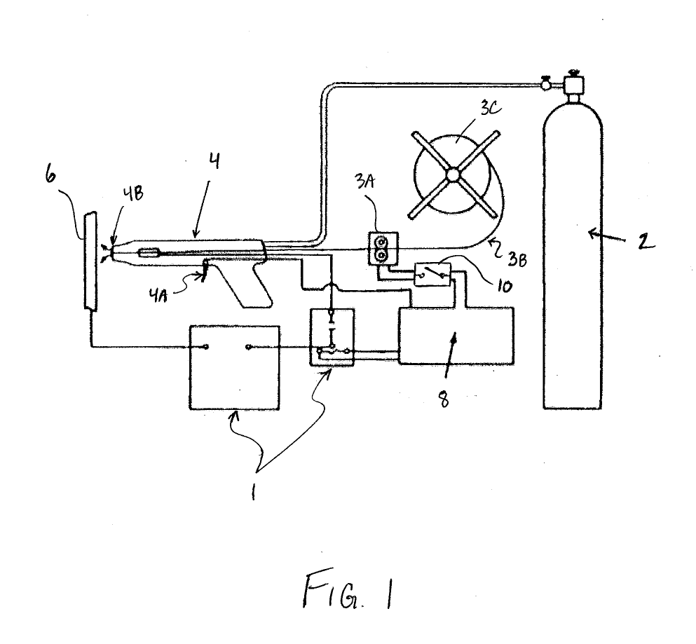

As shown in FIG. 1, welding apparatus which is used in the welding type related to the present invention typically includes a power supply 1, which may be DC as in the illustrated embodiment or AC; a supply of suitable shielding gas 2; a wire-drive system 3A supplying the consumable wire electrode 3B which may be of a solid or flux-cored type; and a welding gun 4 through which the power, shielding gas, and wire electrode are delivered to a workpiece 6 for welding same. The welding apparatus also includes controls 8 which are operatively coupled to at least each of the power supply 1 and the welding gun 4 for (i) setting parameters such as voltage and wire feed speed, and (ii) controlling the voltage, wire feed speed, and gas flow timing during a welding process. A gas flow regulator 9 is also provided (installed on the source of shielding gas) to regulate flow (for example, flow in cubic feet per minute) of the shielding gas from its supply source to the gun 4, in which case the rate of shielding gas flow is set using the flow regulator 9 typically at a start of the welding process. Furthermore, note that a mechanism of the wire-drive system 3A that pulls the wire electrode 3B from a supply reel 3C and pushes the wire electrode through the welding gun may be disposed internally or externally of the welding gun 4.

In the illustrated embodiment, the power supply 1 comprises a constant voltage power source. Therefore, a constant output voltage is one of the preset parameters on the welding apparatus that is established thereon prior to commencing the welding process. Also, the wire feed speed is another one of the preset parameters which is set in advance of performing the welding. The wire feed speed controls an average welding current, and the power source supplies and maintains the constant voltage in order to melt the wire electrode 3B at a required rate.

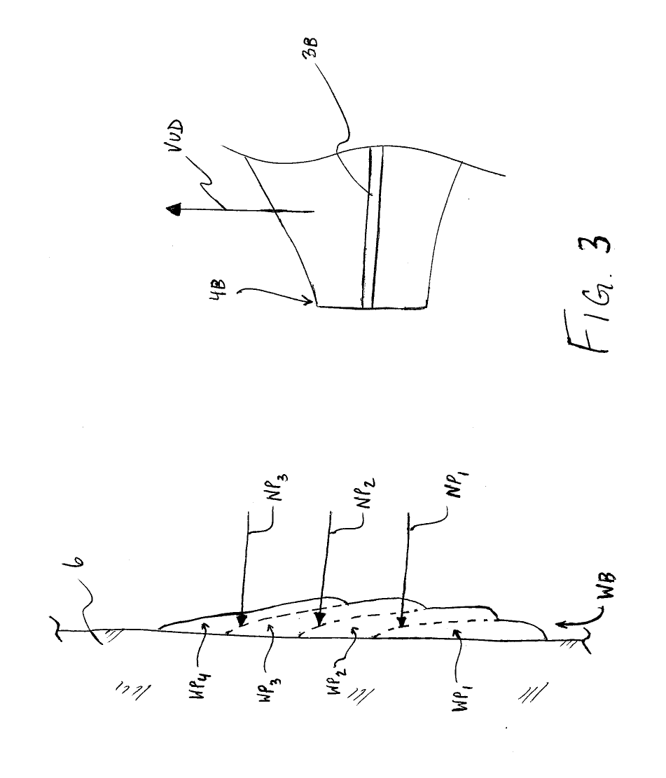

A trigger action, which is carried out or enacted upon a trigger 4A of the welding gun 4 by a human user, is typically operable for feeding the electrode wire 3B so as to enable the welding process and thus form a weld bead such as that indicated at WB in FIG. 3 on the workpiece 6. According to conventional operation, the electrode wire 3B is fed from the welding gun to the workpiece when the trigger 4A is activated in an active position of the trigger action. When the trigger is deactivated so as to reside in an inactive position, the wire electrode stops feeding and the power stops being delivered to a tip 4B of the welding gun. The trigger action also governs delivery of the shielding gas 2. Typically, the shielding gas is delivered from the welding gun during the active position of the trigger when welding is being performed, and when the trigger is deactivated the shielding gas flow ceases a short predetermined duration after feeding of the electrode wire is stopped.

In order to perform the process of vertical upward welding according to the present invention, the welding apparatus of the illustrated embodiment is adapted so as to include an additional controller 10. This vertical-up welding controller 10 is cooperative with the welding apparatus such that the trigger action is regulated by the controller. That is, in the illustrated embodiment, the controller 10 is arranged to override the active position of the trigger action. As such, the trigger action remains in the active position (i.e., the trigger 4A is depressed) throughout the vertical upward welding process, and therefore the vertical upward welding process continues so long as the trigger 4A is depressed meaning that the trigger action is in the active position. It will be appreciated shortly hereinafter that with the controller 10 regulating the trigger action, the human user may focus his/her attention on (i) maintaining a constant distance between the tip 4B of the welding gun and the workpiece, and (ii) moving the welding gun 4 up across the workpiece 6. Furthermore, it will also be appreciated shortly hereinafter that manual control of the welding gun in order to perform the process of vertical upward welding may be very challenging with the time durations which are involved. Also, note that the controller 10 may be regarded as part of the controls 8 of the welding apparatus and may be integrated with this system of controls.

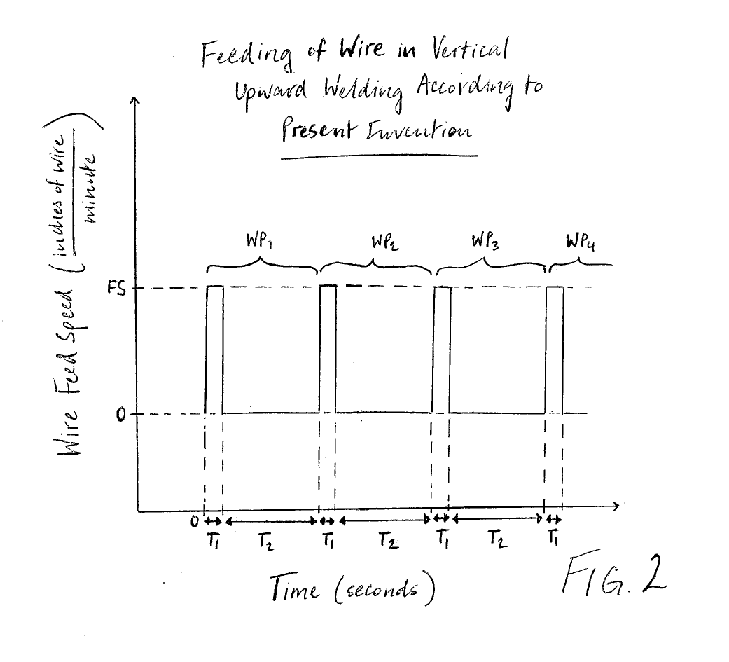

Turning now with reference especially to FIGS. 2 and 3, the process to produce the weld bead WB in mechanically fed wire electrode welding on the workpiece 6 where the weld is to be performed vertically generally comprises the steps of:

a) providing preset parameters on the welding apparatus in order to set up the apparatus, including (i) a prescribed voltage, and (ii) a prescribed wire feed speed ‘FS’;

b) welding the workpiece 6 in the vertically upward direction, with the welding apparatus set at the prescribed voltage and with the electrode wire 3B feeding from the welding gun 4 at the prescribed feed speed FS, for a first predetermined duration ‘T₁’ where an arc is formed between the welding gun 4 and the workpiece 6;

c) halting the feeding of the electrode wire 3B as the welding gun 4 is moved in the vertically upward direction as indicated at VUD', such that the arc is extinguished and so as to interrupt the step of welding in b) for a second predetermined duration ‘T₂’.

As a result of performing the above steps, a weld pulse WP is formed. This weld pulse has a finite length across the workpiece 6, where the workpiece is being welded. This weld pulse is allowed to cool during step c) above, during which the welding gun 4 is still moved upwardly even though the electrode wire 3B is not being fed such that the welding gun is located at a next position NP at the workpiece in preparation for applying and forming another weld pulse WP when step b) above is repeated. Thus, a plurality of the weld pulses form the respective weld bead WB. Therefore, the finite length of each weld pulse WP is less than a total length of the weld bead to be formed on the workpiece. Now, each one of the above steps will be described in more detail below.

Turning to step a) above in further detail, each of the preset parameters that are set prior to performing the act of welding have a prescribed value which may be based on a number of factors including diameter of the electrode wire 3B; type of electrode wire being used (i.e., solid versus flux-cored); and material thickness (of the workpiece 6). In addition to voltage and wire feed speed, the preset parameters may also include gas flow if shielding gas 2 is used. The applicant notes that shielding gas is preferably used with flux-cored wires although this is not required. In this instance where shielding gas is used, type of shielding gas may also be included amongst the factors affecting values of the preset parameters. Suitable shielding gas like argon blends with oxygen or carbon dioxide as well as a smaller percentage of other gases are the most commercially used. Also, some digital/programmable welding apparatus include further parameters or settings that are set on the apparatus in advance of performing the act of welding, such as pre-flow time (for shielding gas), run in time (for wire feed), start time, spot timer, crater time (for wire feed), burn back time, and post flow time (for shielding gas). These preset parameters then remain unchanged from their prescribed preset values over the course of the process for forming the respective weld bead on the workpiece. That is, the prescribed values are not changed by any direct intervention from a human user throughout steps b) and c).

Further to the voltage and wire feed speed parameters, the first and second predetermined durations T₁, T₂ are set prior to performing steps b) and c) of the process, which may be considered part of the preparatory step a) above. For convenience of reference, the first predetermined duration T₁ for which welding is performed is termed ‘ON time’, and the second predetermined duration T₂ for which the electrode wire 3B is stationary so as to not be fed is termed ‘OFF time’. The ON time is sized, in length of time, so that fusion with the workpiece occurs in step b) but molten metal resulting from this fusion is maintained in a suspended state at the workpiece in step b) without dripping from the workpiece. Due to a vertical orientation of the workpiece 6, gravity makes the molten metal conducive to dripping. Therefore, the length of the ON time is sized such that the workpiece is sufficiently heated in order for fusion to occur, by which the molten metal is produced, but the workpiece is not heated for too long a time in which case the workpiece is overheated and the molten metal may drip or run down the workpiece. As such, the molten metal which is entirely red hot during step b) above is held suspended at the workpiece during the ON time.

The OFF time (i.e., the second predetermined duration) is sized, in length of time, based on a rate of cooling of the respective weld pulse. More specifically, the OFF time is sized so that the respective weld pulse which cools during step c) is still in a plastic state, where the metal is molten, when another one of the weld pulses is applied when step b) is repeated for the subsequent weld pulse. In this plastic state, the metal maintains some of the heat from the welding of step b). The presence of some amount of heat is empirically visible by a red spot present on the weld pulse. That is, the weld pulse has cooled so that the redness has reduced in size from covering an entirety of the weld pulse in step b) to the smaller red spot indicating that the weld pulse is still relatively hot. When in this plastic state, the weld pulse is not yet entirely cooled so that any impurities which may be present have not risen to a surface of the weld pulse. Structural integrity of the weld bead WB, formed by the plurality of weld pulses, is maintained by applying the next weld pulse when the previously applied weld pulse is in the plastic state, such that the weld pulses are chemically linked or bonded with one another and the weld bead is thus a continuous string of chemically-interconnected weld pulses.

It will be appreciated that the length of the ON and OFF times is affected by factors including, at least, the voltage; wire feed speed; diameter of the electrode wire 3B; use of solid versus flux-cored electrode wire; shielding gas type; and thickness of workpiece 6. Thus, the ON and OFF times may vary considerably from one application to the other.

It will be appreciated also that the relationship between the size of the first predetermined duration T₁ and the size of the second predetermined duration T₂ depends on the material type of the workpiece 6. Typically, the second predetermined duration T₂ for cooling is longer than the first predetermined duration T₁ for welding, such as when performing the method of the present invention on a steel workpiece. In other cases for different weldable metal materials, the second predetermined duration T₂ may be equal to the first predetermined duration T₁. In yet further instances, the second predetermined duration T₂ may be shorter than the first predetermined duration T₁ such as when the cooling rate of the material is sufficiently higher than the rate for fusion so that the weld pulse cools more quickly than it takes for proper fusion to occur.

With the tip 4B of the welding gun positioned at a prescribed distance from the workpiece, step b) begins when the trigger 4A is depressed so as to be moved into the active position thereby initiating the controller 10. Thus, the electrode wire 3B is fed from the welding gun 4 towards the workpiece at the prescribed wire feed speed FS and the prescribed voltage is formed at the tip 4B of the welding gun. As a result, the arc is formed or struck when the electrode wire contacts the workpiece and the power is transferred from the welding gun to same. The electrode wire is delivered at the prescribed wire feed speed FS to the workpiece for the ON time T₁ (first predetermined duration), as the welding gun is being maintained at the prescribed distance from the workpiece and moved by the human user in the vertically upward direction VUD across the workpiece. FIG. 2 illustrates this first instance of step b) with a first time interval T₁ commencing at coordinate (0, 0) on the graph of FIG. 2. Although there are a number of factors affecting ON time as mentioned in the previous paragraph, the ON time may lie in a prescribed range between 0.01 seconds and 1.2 seconds. In other instances, the ON time may lie in a prescribed range between 0.1 seconds and 1 second and provide similar functionality to the prescribed range between 0.01 seconds and 1.2 seconds depending on the factors which were described as affecting the values of the preset parameters.

Once the ON time fully elapses, the controller 10 transitions to step c) above where the electrode wire is brought to a standstill. That is, while the trigger action remains in the active position, the controller halts the feeding of the electrode wire 3B as the welding gun 4 is maintained at the prescribed distance from the workpiece and is continued to be moved upwardly as indicated by the arrow VUD in FIG. 3. A first time interval T₂ as shown in FIG. 2 illustrates this first instance of step c) immediately following the first instance of step b), where the wire feed speed is zero. The arc thus extinguishes with the electrode wire no longer being in contact with the workpiece. With the arc extinguished, the weld pulse WP which has now been formed, like that indicated at WP₁ in FIG. 3 partially by solid line and partially by dashed/broken line, is permitted to cool as power has stopped flowing from the gun to the workpiece. Shielding gas may continue to be delivered for at least a short time after the feeding of the electrode wire is halted as the weld pulse WP₁ cools. While the weld pulse cools, the tip 4B of the welding gun is located by the human user at the next position NP, like that indicated at NP₁, which is at a top of the weld pulse WP₁ which was just formed. That is, the next position is located at or adjacent a periphery of the respective weld pulse at the top thereof, and typically centered thereat. It will be appreciated that the prescribed voltage may be maintained at the welding gun's tip 4B during step c) while the electrode wire is not feeding. However, the prescribed voltage may also be removed from the tip of the welding gun during step c).

Before the weld pulse WP₁ which has just been applied is entirely cooled, the next weld pulse indicated at WP₂ is applied at the next position NP₁ of the welding gun by repeating step b). Since the trigger action remains in the active position throughout steps b) and c) above, the controller alternates back to step b) as shown by a second instance of time interval T₁ in FIG. 2 and the electrode wire 3B is fed again from the welding gun 4 at the prescribed wire feed speed FS for the duration of the ON time. If the prescribed voltage had been removed from the tip of the gun in step c), then this prescribed voltage is reapplied to the tip 4B so that the step of welding can be performed.

Although there are a number of factors affecting OFF time, the OFF time may lie in a prescribed range between 0.2 seconds and 3 seconds. In other instances, the OFF time may lie in a prescribed range between 0.5 seconds and 2 seconds provide similar functionality to the prescribed range between 0.2 seconds and 3 seconds depending on the cooling rate of the weld pulse and the factors which were described as affecting the values of the preset parameters.

Note also that the upward travel speed by which the welding gun is moved across the workpiece in the VUD direction is thus determined by the OFF time, which is in turn determined by the rate of cooling of the individual weld pulse.

Therefore, by reiterating steps b) and c) above as better shown by means of plot of wire feed speed in FIG. 2, the weld bead WB is formed as schematically shown in FIG. 3. In the example as provided in FIGS. 2 and 3, the weld bead WB is formed from four weld pulses which are formed by the process of the present invention. WP₁ indicates a first one of the weld pulses which is applied and defines the bottom of the weld bead. A second one of the weld pulses which is applied as indicated at WP₂ is formed when the welding process resumes at position NP₁ with reiteration of step b) thereat. The broken line and solid line of WP₁ in FIG. 3 together illustrate an appearance of the molten metal at the first weld pulse WP₁ prior to application of the next weld pulse WP₂ so as to show where the welding gun is aimed relative to the previously produced weld pulse in order to form the next weld pulse WP₂ (which is next in relation to WP₁). Similarly, a third one of the weld pulses WP₃ is formed when step b) is repeated at the position indicated at NP₂, and a fourth one of the weld pulses WP₄ defining a top end of the weld bead is formed when step b) is repeated at position indicated at NP₃.

Since the OFF time is sized so that the previously applied weld pulse is in the plastic state when the next weld pulse is applied, the weld pulses are chemically linked so that the weld bead WB has an uninterrupted core portion over the entire length of the weld bead. A structure of the core portion of the weld bead is chemically uninterrupted in that this structure is not interrupted by laminations of impurities or slag that build up on a surface of the respective weld pulse once it is fully cooled. Thus, the entire weld bead comprises a core portion having continuously formed weld metal, where weld metal of individual weld pulses is contiguous each with the next. Therefore, a proper weld bead is produced even though the bead is formed of individually applied weld pulses.

The alternation between steps b) and c) above continues for any respective number of iterations so long as the trigger action is in the active position. In general, the welding process of the present invention is terminated when the trigger action returns to the inactive position, so that the welding process may have a different number of welding periods as denoted by T₁ and cooling periods as denoted by T₂.

Additionally, FIG. 2, which shows a plot of the wire feed speed over time of the welding process of the present invention, more clearly illustrates a typical scenario in which the period of welding in step b) occurs for a relatively short first predetermined duration T₁, where the feeding of the electrode wire occurs at its prescribed wire feed speed value FS, compared to the period of cooling provided by step c) where the feeding of the electrode wire is halted as indicated by an instantaneous wire feed speed of zero for the second predetermined duration T₂ which is longer than the ON time T₁. The welding process of the present invention thus comprises pulsing of the feeding of the electrode wire as better shown in FIG. 2.

Furthermore, as better illustrated in FIG. 2 there is zero background current throughout steps b) and c) meaning that the minimum current value which is attained during the welding process is zero. Therefore, current flow to the workpiece is interrupted as is the arc, which is repeatedly formed and then extinguished.

Additionally and moreover, FIG. 2 shows the alternation between actively welding and permitted cooling for the example where the weld bead is formed from four weld pulses WP₁ through WP₄ as illustrated in FIG. 3.

An example set of preset parameters, along with the workpiece to be welded, is provided below for setting up a non-programmable welding machine apparatus in relation to the welding process according to the present invention:
Workpiece thickness: 3/16″-¼″
Workpiece material type: steel
ON time: 0.30 seconds
OFF time: 1.2 seconds
Welding gun: positioned 10-15° above normal line to surface of workpiece

If using a programmable welding machine apparatus, the following additional parameters, which are known to a person with ordinary skill in the art, may be set as follows:
Pre-flow time: 0.0 seconds
Run in time: 0.0 seconds
Start time: 0.0 seconds
Spot timer: 0.0 seconds
Crater time: 0.0 seconds
Burn back time: 0.0 seconds (0.1-0.3 seconds if needed)
Post flow time: 1.3 seconds (i.e., 0.1 seconds longer than OFF time)

Furthermore, example operating instructions for the vertical upward welding process are as follows:

1. Set voltage, inches of wire per minute, and gas flow to the same parameters as you would for a good hot weld bead in the flat position, in accordance with the wire diameter and type as well as the material thickness.

2. Set the ON time pulse for 0.30 seconds as a starting point for 3/16″-¼″ steel plate.

3. Set the OFF time dwell for 1.2 seconds to start with.

4. Position the welding gun 10-15 degrees above 90 degrees and with an appropriate standoff distance for the wire diameter and type.

5. Depress the trigger of the welding gun.

6. After the first pulse fires quickly move to the center near the top edge of the deposit before the gun fires again.

7. Keep the trigger depressed and repeat step 6 for each consecutive weld pulse until the desired weld bead length is reached then release the trigger.

The length of the ON time pulse should be long enough to get proper wash and fusion to the base metal (i.e., workpiece) but not so long that the respective weld pulse deposit sags or drips. The OFF time dwell is determined by the cooling rate of the individual pulse or deposit. When the arc occurs the weld pulse will be molten and entirely red hot; as the weld pulse cools the red colour will fade to a small red spot near the top center. Just before the spot fades entirely the welding gun should be moved up and the wire aimed at the spot before the gun fires again. The OFF dwell time may have to be adjusted so the gun fires precisely at this moment. This will determine the upward travel speed.

As mentioned earlier, control of the process for vertical upward welding according to the present invention is provided by the controller 10, which especially affords the short periods of welding that are on the order of one second or shorter without having to operate the trigger 4 intermediately throughout the welding process. Quickness of human user response to engaging the trigger 4 may otherwise make such prescribed ON time values challenging to attain and successful results of this welding process less likely. For such reasons, the controller 10 provides accurate and precise control of the vertical upward welding process and allows the human user to concentrate on moving the welding gun at a proper upward travel speed in the vertically upward direction VUD and maintaining the prescribed distance between the workpiece 6 and the welding gun's tip 4B.

The process for vertical upward welding may be compatible, and in some cases complementary, with well-known pulse programs installed on conventional programmable welding machines like those provided by manufacturer Lincoln.

Since various modifications can be made in my invention as herein above described, and many apparently widely different embodiments of same made, it is intended that all matter contained in the accompanying specification shall be interpreted as illustrative only and not in a limiting sense.

1. A process for performing vertical upward welding so as to form a weld bead on a workpiece using welding apparatus which includes a welding gun and an electrode wire which is mechanically fed by the welding apparatus, the process comprising the steps of:
a) providing preset parameters on the welding apparatus including (i) a voltage, and (ii) a wire feed speed;
b) welding the workpiece in a vertically upward direction with the welding apparatus set at said voltage and with the electrode wire feeding from the welding gun at said feed speed for a first predetermined duration where an arc is formed between the welding gun and the workpiece;
c) halting the feeding of the electrode wire as the welding gun is moved in said vertically upward direction, such that the arc is extinguished and so as to interrupt the step of welding in b) for a second predetermined duration;
whereby a weld pulse having a finite length is formed on the workpiece;
whereby the respective weld pulse is permitted to cool during step c);
wherein movement of the welding gun during step c) locates the welding gun at a next position at the workpiece in preparation for forming another one of the weld pulses when step b) is repeated;
wherein a plurality of the weld pulses form the weld bead.

2. The process for performing vertical upward welding according to claim 1 wherein the first predetermined duration is sized so that fusion with the workpiece occurs in step b) but molten metal resulting from said fusion is maintained in a suspended state at the workpiece in step b) without dripping from the workpiece.

3. The process for performing vertical upward welding according to claim 1 wherein the second predetermined duration is sized based on a rate of cooling of the respective weld pulse.

4. The process for performing vertical upward welding according to claim 1 wherein the second predetermined duration is sized so that the respective weld pulse which cools during step c) is in a plastic state when said another one of the weld pulses is applied when step b) is repeated therefor.

5. The process for performing vertical upward welding according to claim 4 wherein the next position at which the welding gun is located in preparation for forming said another one of the weld pulses is at a top of the weld pulse applied previously thereto that is in the plastic state, such that said another one of the weld pulses is overlapped with the previous one of the weld pulses.

6. The process for performing vertical upward welding according to claim 1 wherein there is zero background current throughout steps b) and c).

7. The process for performing vertical upward welding according to claim 1 wherein the voltage is maintained at the welding gun during step c) while the electrode wire is not feeding.

8. The process for performing vertical upward welding according to claim 1 wherein steps b) and c) are managed by a controller which is cooperative with the welding apparatus such that a trigger action, which is enacted on the welding gun by a human user and operable for feeding the electrode wire from the welding gun, is regulated by the controller.

9. The process for performing vertical upward welding according to claim 8 wherein the trigger action is in an active position throughout steps b) and c), where the electrode wire is arranged to be fed in this active position, and the controller overrides the active position of the trigger action such that the electrode wire is halted in step c).

10. The process for performing vertical upward welding according to claim 9 wherein steps b) and c) are repeated for any respective number of iterations so long as the trigger action is in the active position.

11. The process for performing vertical upward welding according to claim 1 wherein the first predetermined duration of time lies in a prescribed range between 0.01 seconds and 1.2 seconds.

12. The process for performing vertical upward welding according to claim 1 wherein the second predetermined duration of time lies in a prescribed range between 0.2 seconds and 3 seconds.
